(19) United States
(12) Patent Application Publication
(10) Pub. No.: US 2015/0215318 A1
(43) Pub. Date: Jul. 30, 2015

(54) CASE MANAGEMENT SYSTEM

(71) Applicant: TOPLEVEL COMPUTING LIMITED, STONEHOUSE (GB)

(72) Inventor: Stephen BRIMLEY, Stroud (GB)

(73) Assignee: TOPLEVEL COMPUTING LIMITED, STONEHOUSE (GB)

(21) Appl. No.: 14/164,398

(22) Filed: Jan. 27, 2014

(51) Int. Cl. H04L 29/06

(52) U.S. Cl. CPC H04L 63/10; H04L 63/061

(57) ABSTRACT

A case management system includes a first application server 10 and a second application server 12, the first server 10 being associated with a first case data store 22 and the second server being associated with a second case data store 24;
the first and second case data stores 22, 24 containing data relating to a plurality of cases and being connected through a communication protocol 26 allowing the case data stores 22, 24 to be synchronised with each other;
a case workflow definition (50) being provided, the case workflow definition (50) including a plurality of stage definitions (54, 56, 58, 60, 62) and being loaded onto each of the first and second application servers 10, 12;
each stage definition (54, 56, 58, 60, 62) specifying how the data for an individual case should be processed at that stage in the workflow including specifying any permitted user interactions;
each stage definition (54, 56, 58, 60, 62) including an indicator for indicating which of the first and second servers 10, 12 will carry out the processing according to the definition at that stage;
and the first and second servers 10, 12 being adapted to carry out only the appropriate processing according to the indicator.

The present invention relates to a case management system, and particularly but not exclusively to a case management system running on two or more separate server machines with different security constraints applying to each server.

### BACKGROUND TO THE INVENTION

Computer-based case management systems are well known, and are widely used in organisations, particularly government organisations, which have to manage structured interactions with external organisations or members of the public.

For example, a grant-awarding organisation may use a case management system to process grant applications. An application for a particular grant will typically follow a structured path or workflow, with a number of stages each requiring input from a particular entity. Each case will follow this path until a decision is made by the grant-awarding organisation as to whether or not to award the grant.

As an example, a grant application may require the following stages:
an initial application from an external person (the Applicant);
an initial checking stage by a junior employee inside the grant-awarding organisation, which includes indicating any deficiencies in the application and what if any further information is required;
a response from the Applicant, providing whatever further information was requested and correcting any deficiencies;
a request for references from another external person (the Referee);
a response from the Referee, providing a reference in support of the application;
a decision from a junior employee in the grant-awarding organisation as to whether the application should be approved or refused;
if the application is approved by the junior employee, then a secondary approval by a

Director is required before release of funds;
the Applicant is informed of the final outcome of the case.

In this example, input is required from two different people inside the grant-awarding organisation (the junior employee and the Director), and from two different people outside the organisation (the Applicant and the Referee).

It is of course important to maintain the security of the organisation's computer systems, and for that reason granting the external persons direct access to the case management system run by the grant-awarding organisation is unlikely to be acceptable. However, for the purposes of efficiency it is desirable to provide the external persons involved with the case with some form of interface to the system, so that re-typing or other manual steps are not required to enter the data provided by them into the system.

In existing systems, case management software is installed on a server or servers accessible to those inside the organisation. The case management software allows users inside the organisation to participate in end-to-end management of the case. To provide the possibility of input from external persons, a separate piece of software is produced, which is installed on a server accessible to users outside the organisation. An interface between the two disparate solutions is provided, which allows sharing of data between the servers in a controlled way.

The reason for this approach is to maintain security whilst allowing a convenient level of access to data depending on requirements. Tight controls may be imposed on access to the server which is internal to the organisation. Passwords are almost always used, and many systems also include a second level of authentication (for example, a one-time passcode generated by a hardware device, or a smartcard). Furthermore, access to the internal server by external entities will normally be prevented at a network level. That is, the internal server can only be accessed by those using devices connected to an internal network. Combined with good physical security, these measures can provide a good level of assurance that no unauthorised access to the internal server can occur, and indeed that a user logged in to the system has been correctly identified. Those inside the organisation are likely to be essentially trustworthy, which further reduces the risk.

Because the probability of unauthorised access is considered to be low, substantially unrestricted access may be provided to the data in the server to those who are able to log on. For example, access to the data may be provided to suitably authorised users in a way which allows it to be aggregated or exported, in order to produce summaries and reports for management information purposes. In the grant application example, it may be desirable to compare aspects of different applications to ensure that a consistent policy is being applied.

On the other hand, it is not practical to control access to the external server to the same degree. Typically, users will be authenticated with a username and password, but because the external users are difficult to control there can be no guarantee that they will store their passwords securely. External users will generally expect to be able to access the system from any internet-connected computer, and thus the above-described examples of network-level access control cannot be used. The probability of unauthorised access to the external server is therefore inevitably higher. Moreover, even authorised users cannot necessarily be trusted. They must not be allowed to access data which does not relate to their specific case, and must not be allowed to complete stages of each case which should not be completed by them (for example, an Applicant should not be allowed to approve his own grant application.)

Allowing access to the external server creates a security risk. The way that this risk is managed is usually to attempt to control the amount of data which is available and the actions which can be performed on the external server. The interface between the two servers should only allow data to pass to the external server which is actually needed for the external persons to be able to complete their respective stages, and the software on the external server should tightly control what actions can be performed.

The problem with this approach is that, in many cases, the external person needs to see substantially all of the data which applies to his particular case in order to complete his stages. Restricting the flow of data to allow only the required data to pass is therefore an essentially meaningless restriction. As there is always a possibility that software contains bugs which result in security flaws, and there is also a possibility that login credentials might be obtained by an attacker, there is a risk that an unauthorised person might gain access to substantially all of the data which is stored on the external server.

Even in situations where this sort of system does provide a reasonable compromise between security and convenience, implementation can be expensive. Essentially two separate pieces of software have to be provided, configured, installed, and integrated. Changes to the software running on the internal server may have the effect of requiring changes in turn to the software running on the external server. Because the security comes mainly from restricting the data flow at the interface between the systems, and the restriction on the data flow which is required will be highly dependent on the actual type of case which is being managed, the interface has to be essentially custom designed for each individual implementation.

It is an object of the invention to solve the above mentioned problems.

### STATEMENT OF INVENTION

According to a first aspect of the invention, there is provided a case management system including a first application server and a second application server, the first server being associated with a first case data store and the second server being associated with a second case data store;

the first and second case data stores containing data relating to a plurality of cases and being connected through a communication channel allowing the case data stores to be synchronized with each other;

a case workflow definition being provided, the case workflow definition including a plurality of stage definitions and being loaded onto each of the first and second application servers;

each stage definition specifying how the data for an individual case should be processed at that stage in the workflow including specifying any permitted user interactions;

each stage definition including an indicator for indicating which of the first and second servers will carry out the processing according to the definition at that stage;

and the first and second servers being adapted to carry out only the appropriate processing according to the indicator.

Typically, the first server will be accessible only by users within a particular organisation. Usually this will be at least in part because the first server is connected to the organisation's internal network, and network-level controls are in place to prevent access from devices outside of that network. The second server may be accessible by external users, for example via the internet.

It will be understood that “server” may refer to a physical machine, or a virtual machine, or just to a piece of software which runs on a machine and provides substantially the functions of a server. It will also be understood that multiple machines may fulfil the role of each “server” to provide fault tolerance and/or load balancing in ways which will be familiar to the informed user.

The case data will include at least an indication for each case as to what stage that case is currently at, and will also include further details, depending on the nature of the cases being managed in a particular deployment.

The communication channel allows the data stores to remain synchronised with each other. A communication protocol will control this synchronization. The first and second case data stores may contain substantially the same data, and in some implementations each may contain substantially all data relating to all cases in the system. Typically, however, that data will be stored in different ways. For example, the second (externally accessible) server may be associated with a case data store which stores case data in an encrypted form. In particular, the data for each individual case may be encrypted with a different key. This limits the possibility that a user on the external server will be able to access data which relates to a case which does not concern him. It also prevents aggregation of data by external users.

On the other hand, the first case data store will typically be a straightforward, unencrypted, relational database. This allows internal users to access all data from all cases, and to generate aggregated or comparative reports.

Generally, the case management system allows for a case management system having a single unified design across two or more servers, potentially with different security constraints applying to each server or to each data store. Each server provides access to the case by a subset of the total user community. In the simplest case, one server is provided for users internal to an organisation and one server is provided for external users, but more complex scenarios will be envisaged. For example, a first server may be provided on the internal network of a grant-awarding organisation, a second server may be provided on the internet for access by external customers, and a third server may be provided on the internal network of a supplier organisation which supplies to external customers certain services which can be funded by grants from the grant-awarding organisation.

The system allows a single case workflow definition to be prepared and installed across all of the servers in a particular system. The workflow definition defines what happens at each stage of a particular case, including defining which users in which organisations may make which changes to the case, and which server will process that particular stage of the case. Typically, some of the stages will include decisions which are either made by a person interacting with the system, or by some automated algorithm. Depending on the decision, the case will then move to one of a number of alternative next stages.

The particular security configuration which is needed in each environment can then be applied to each server. The case management system behaves differently depending on which server it is running on in order to comply with the security configuration of that server. The security configuration of a server includes many aspects, including the environment in which the server is installed, including physical security, network security, operating system setup and so on. More particularly, the security configuration may include a data access configuration which defines how data from the data stores is accessed by each server. For example, one data access configuration may cause data to be encrypted in the server's associated data store, the encryption being with a key unique to each case.

Each stage is designated to be run on a specific server within the case management system, and the case management system will not allow a stage to be run on a server which is not designated to run that stage.

Because the case management system is based on a single software product which is installed across all servers in the system, which are all loaded with the same workflow definition, the case management system is quick, easy, and inexpensive to deploy and configure for a particular type of case to be managed. When used in conjunction with appropriate security configurations, it allows all those involves access to a single shared view of the entire case process, without compromising the confidentiality of the data.

According to a second aspect of the invention, there is provided a computer program for use simultaneously on each of a group of servers, each server being associated with a respective data store, the computer program when executed on each server causing the server to:
read a case workflow definition, the case workflow definition including a plurality of stage definitions, each stage definition specifying how data for an individual stage should be processed at that stage including specifying any permitted user interactions, and each stage definition including an indicator for indicating which server or servers in the group will carry out the processing according to the definition at that stage,
retrieve case data from the server's associated data store, the case data including for each case an indication of what stage that case is at,
for all cases which are at a stage which the stage definition indicates may be carried out on the current server, processing the case data according to the stage definition, including seeking user input where required and specified in the stage definition, and
returning processed case data to the server's associated data store.

The program, when installed on at least two servers with associated data stores, may be used in conjunction with a synchronisation system which keeps the data in the data stores associated synchronised. Changes to case data in one data store which occur as a result of processing on the server associated with that data store will therefore propagate to all the other data stores. When enough processing (including waiting for and obtaining any required user input) has been done to finish a particular stage, the case will be “moved on” to the next stage, in that the indication of what stage that case is at will be updated.

Each server in the group will be identified by an identifier. The indicator in a stage definition will correspond with the identifier of one of the servers in the group.

The program will not allow processing to be carried out on data relating to cases which are at a stage which is not flagged for processing on the particular server.

It will be appreciated that the effects of the program on the server as described above are the essential functions which the server running the program must perform. They are not steps which must necessarily be executed in order by the server. In most embodiments, for example, it is clear that data must be repeatedly read from the data store, since it may have been updated by processing on other servers in the group. Where a stage requires user input, the processing carried out must include soliciting and waiting for that input. In a typical embodiment, this will be done by making available an interface, often a web interface, which can be accessed by authorized users who are able to provide the input at that stage of the processing. The “processing” of a particular case may therefore take several days or weeks simply waiting for input. Clearly, therefore, multiple cases need to be “processed” in parallel in most embodiments.

The program may further cause the server to read a data access configuration and to retrieve and store case data in the associated data store in accordance with that data access configuration. In a typical system the same workflow definition but different data access configurations will be loaded onto each server in the group.

The data access configuration controls how the data is retrieved from and stored in the data store. For example, a typical “cautious” data access configuration, which might be suitable for use on an internet-facing server, might include obtaining an encryption key relating to an individual case, decrypting the case data retrieved from the data store with that key, and re-encrypting the data after processing and before returning it to the data store. A less cautious data access configuration, which might be used on a server to which access from outside an internal network is prevented by other means, might simply confirm that a logged-in user is permitted to access particular data before obtaining it from the data store.

The data access configuration, which controls how data is stored and accessed, is just part of the overall security configuration of a server, which will be understood to possibly include aspects of the environment in which the server is installed, as well as the way in which the software including the operating system on the server is configured.

It will be understood that at least one server in the group must be capable of creating new cases. The “create new case” stage can be thought of as a special case of processing a stage of a case, although where a new case is being created there will be no “retrieve case data” step.

The computer program may be in the form of computer program code recorded on a computer readable medium.

According to a third aspect of the invention, there is provided a method of deploying a case management system comprising the steps of:
providing a first server, and executing on the first server computer program code defining a case management software application;
providing a second server, and executing on the second server the computer program code;
providing a first data store associated with the first server;
providing a second data store associated with the second server;
providing means for synchronizing the first and second data stores;
creating a case workflow definition including a plurality of stage definitions, each stage definition including an indicator for indicating which of the first and second servers will carry out the processing according to the definition at that stage;
loading the case workflow definition onto the first and second servers.

The program code may be a computer program according to the second aspect of the invention.

The method of deploying the case management system may further comprise the steps of:
applying a security configuration to the first server; and
applying a security configuration to the second server.

The security configurations applied to the first and second servers may be different. One security configuration is likely to be more “cautious” than the other. The security configuration may in particular include a data access configuration which is read by the case management software and which defines how data is stored in and retrieved from each server's associated data store

According to a fourth aspect of the invention, there is provided a computer readable medium having stored thereon a data structure defining a case workflow definition suitable for use with case management software, the case workflow definition including a plurality of stage definitions, each stage definition including an indicator for indicating which of the first and second servers will carry out the processing according to the definition at that stage.

In use, the case workflow definition may be loaded onto each of a group of servers which are executing computer program code defining a case management software program. Each server will carry out only the processing according to the definition at that stage.

### DESCRIPTION OF THE DRAWINGS

To provide the skilled person with a better understanding of the invention, embodiments will now be described as examples only, with reference to the accompanying drawings, in which:

FIG. 1 is a schematic diagram of a case management system in accordance with the invention; and

FIG. 2 is a schematic diagram of a workflow definition for use in the case management system of FIG. 1.

### DESCRIPTION OF THE PREFERRED EMBODIMENT

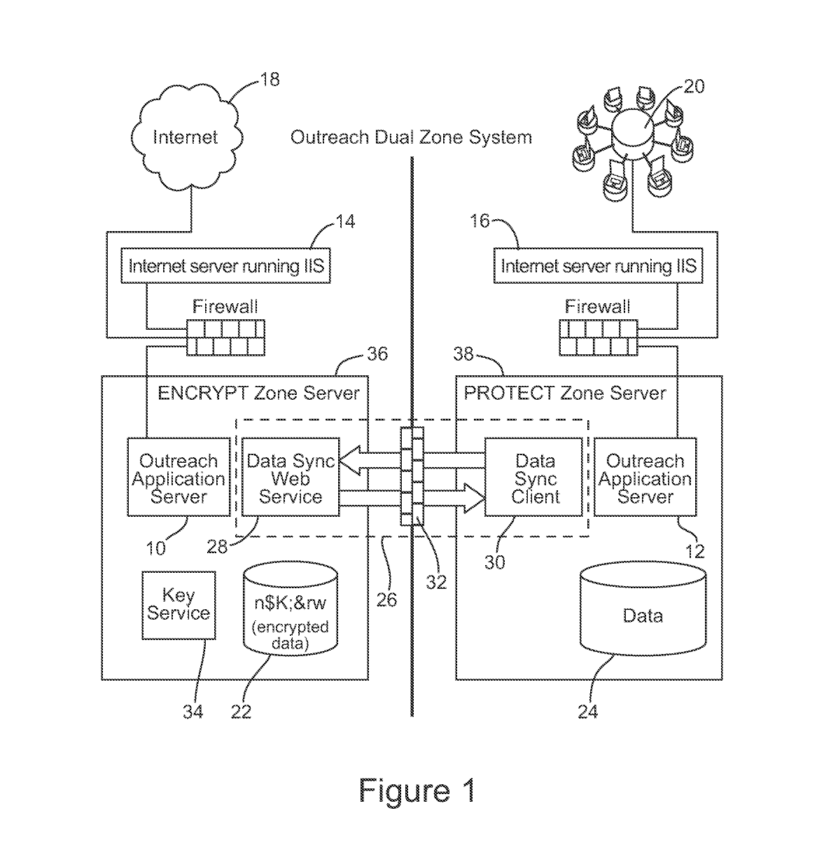

Referring firstly to FIG. 1, the overall architecture of a case management system is shown. The case management system comprises a first application server 10 and a second application server 12. Each of the servers provides an interface to users via a corresponding web server 14, 16. Web server 14 is accessible from any host connected to the Internet 18, whereas web server 16 is accessible only from hosts on a single IP network 20. Typically, network 20 will be a network internal to an organisation, to which only employees or other trusted users have access.

The first application server 10 is associated with and in communication with a corresponding first data store 22, and the second application server 12 is associated with and in communication with a corresponding second data store 24. The data stores 22, 24 store case data. The first application server 10 can store and retrieve data in and from the first data store 22, and the second application server 12 can store and retrieve data in and from the second data store 24.

Synchronization means 26 are provided for synchronizing the data between the two data stores 22, 24. In other words, the data stores 22 and 24 should always contain exactly the same data, because changes to the data in one data store will be propagated to the other data store by the synchronization means 26. The synchronization means 26 in a typical embodiment will include a synchronization program 28 associated with the first data store 22 and a synchronization program 30 associated with the second data store 24, and a communication channel 32 which will typically be an IP network, but may be any other suitable channel.

In this embodiment, the data in the first data store 22 is encrypted. The case data in the data stores 22, 24 includes data relating to multiple different cases, and when it is stored in the first data store 22 data relating to an individual case is encrypted with a key unique to that case. When the data relating to a case needs to be retrieved and decrypted, the correct key is retrieved from a key service 34. The manner in which the key service stores and distributes keys securely is outside of the scope of this invention, but various suitable systems will be familiar to the skilled person.

Encrypting case data in the first data store 22 provides a safeguard against unacceptable aggregations of data. Although data for an individual case can be retrieved with the correct key, no one key can possibly be used to retrieve data relating to more than one case. The risk of data loss is therefore limited.

The case data in the second data store 24 in this embodiment is unencrypted, although it will be understood that in some deployments a level of encryption may be desirable in this data store as well. However, the case data in the second data store 24 will usually be stored in such a way that data for multiple cases can be retrieved, to create lists and reports for management information purposes.

In this embodiment, the first application server 10, first synchronization program 28, first data store 22 and key service 34 are all software applications running on the same physical machine 36. The second application server 12, second synchronization program 30 and second data store run on a second physical machine 38. However, the skilled person will appreciate that multiple machines or virtual machines may be used, depending on the scale and requirements of a particular deployment. Web servers 14 and 16 may in some cases also be on the same machines as their associated application servers.

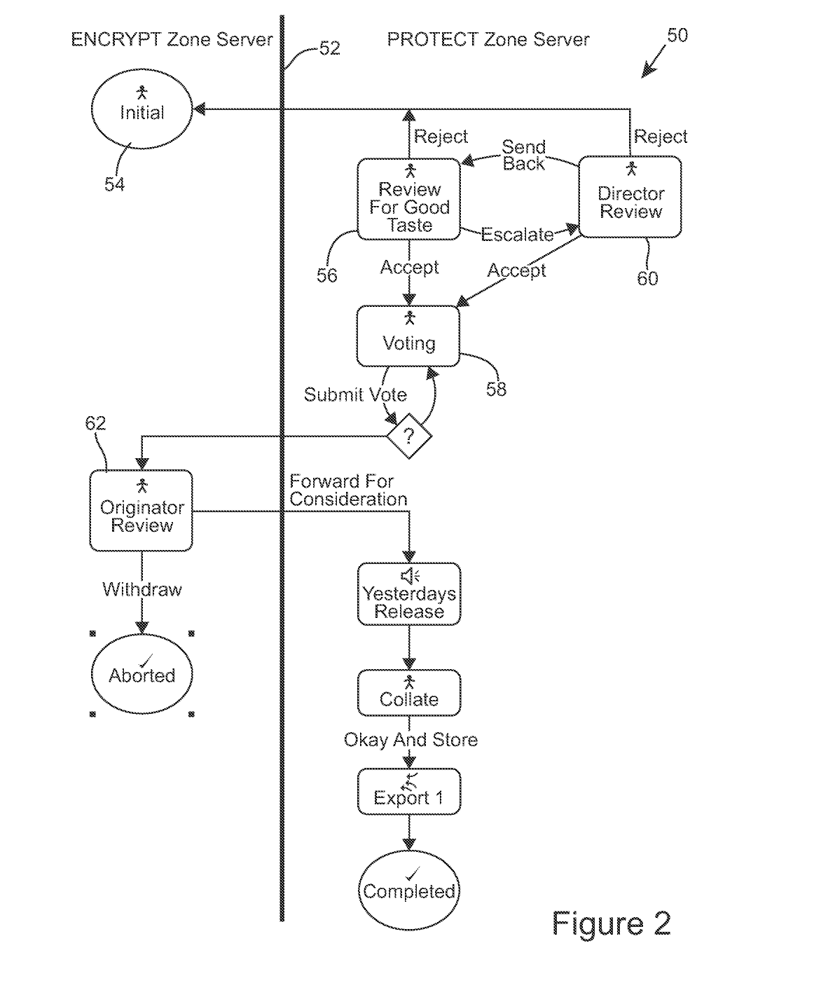

Referring now to FIG. 2, a representation of a workflow definition is generally indicated at 50. The workflow definition is shown graphically, and may be created in a graphical application. However it will be appreciated that other representations and means of creating workflow definitions are possible.

In FIG. 2, boxes represent stage definitions. Each stage definition is flagged to run either on the first application server (10) or the second application server (12). In this particular graphical representation, the stages which are flagged for execution on the first server (10) are to the left of the dividing line 52, and the stages which are flagged for execution on the second server (12) are to the right of the dividing line 52. The flag is also shown graphically by the use of different coloured icons to indicate which server a stage is to be executed on. It will be understood that in some implementations, a particular stage may be flagged for execution on any of a number of servers.

The workflow definition 50 shown models a process for including an item proposed by a member of the public in a publication. The member of the public accesses the first application server 10 via its associated web server 14, and submits his proposed item. The first stage definition 54 of the workflow definition 50 defines this action of soliciting and waiting for input, and when valid input is received, moving to the next stage. The next stage definition 56 also involves a user input, this time from a member of staff inside a publishing organisation who accesses the second application server 12 through its associated web interface 16. The member of staff assesses whether or not the submitted item meets the organisation's standards of good taste. If not, it is rejected and the case moves back to the initial stage 54 so that the user can suggest another item. If the item meets the standard then the case moves to the next stage 58, which involves several entities inside the publishing organisation voting for or against the submission. If the member of staff is unable to reach a decision on the matter of good taste, perhaps because it is a borderline case or one which raises issues which are particularly likely to be contentious, then the question of good taste can be escalated to a more senior member of staff, moving the case to yet another stage 60.

If the submitted item attracts sufficient interest from voters in the publishing organisation, then it is moved to an “originator review” stage 62. The member of the public then has a final opportunity to withdraw the item or forward it back for publishing. If he chooses to forward it for publication, then a number of stages, some of them automated, take place inside the publishing organisation to include the submitted item in the next publication.

The case management system is easy and cheap to deploy and configure, because a single software application can be installed on both servers. A security configuration can then be applied to each of the servers, which controls the way in which data is stored and accessed by each server. The security configuration will often be different, since the servers inside and outside the organisation are exposed to different risks.

The workflow definition loaded onto each server defines how the software application on each server behaves. In particular, each server will only process the stages of the workflow definition which are flagged for processing on that server.

The embodiments described above are provided by way of example only, and various changes and modifications will be apparent to persons skilled in the art without departing from the scope of the present invention as defined by the appended claims.

1. A case management system including a first application server and a second application server, the first server being associated with a first case data store and the second server being associated with a second case data store;
the first and second case data stores containing data relating to a plurality of cases and being connected through a communication channel allowing the case data stores to be synchronised with each other;
a case workflow definition being provided, the case workflow definition including a plurality of stage definitions and being loaded onto each of the first and second application servers;
each stage definition specifying how the data for an individual case should be processed at that stage in the workflow including specifying any permitted user interactions;
each stage definition including an indicator for indicating which of the first and second servers will carry out the processing according to the definition at that stage;
and the first and second servers being adapted to carry out only the appropriate processing according to the indicator.

2. A case management system as claimed in claim 1, in which a first security configuration is applied to the first server and a second security configuration is applied to the second server.

3. A case management system as claimed in claim 2, in which the first security configuration includes at least a first data access configuration specifying how the first server reads from and writes to its associated data store, and the second security configuration includes at least a second data access configuration specifying how the second server reads from and writes to its associated data store.

4. A case management system as claimed in claim 3, which the first data access configuration results in data in the data store associated with the first server being encrypted.

5. A case management system as claimed in claim 4, in which case data relating to a particular case in the data store associated with the first server is encrypted with a key unique to that particular case.

6. A case management system as claimed in claim 5, in which case data relating to a particular case in the data store associated with the second server is not encrypted with a key unique to that particular case.

7. A case management system as claimed in claim 1, in which a user interface of the first server is accessible from the Internet and a user interface of the second server is accessible only from hosts within a particular network.

8. A computer program for use simultaneously on each of a group of servers, each server being associated with a respective data store, the computer program when executed on each server causing the server to:
read a case workflow definition, the case workflow definition including a plurality of stage definitions, each stage definition specifying how data for an individual stage should be processed at that stage including specifying any permitted user interactions, and each stage definition including an indicator for indicating which server or servers in the group will carry out the processing according to the definition at that stage;
retrieve case data from the server's associated data store, the case data for each case including an indication of what stage that case is at;
for all cases which are at a stage which the stage definition indicates may be carried out on the current server, processing the case data according to the stage definition, including seeking user input where required and specified in the stage definition; and
storing processed case data in the server's associated data store.

9. A computer program as claimed in claim 8, the computer program further causing the server to read a data access configuration and to retrieve and store case data in the associated data store in accordance with that data access configuration.

10. A computer program as claimed in claim 8, in which the computer program is provided in the form of computer program code recorded on a computer readable medium.

11. A method of deploying a case management system comprising the steps of:
providing a first server, and executing on the first server computer program code defining a case management software application;
providing a second server, and executing on the second server the computer program code;
providing a first data store associated with the first server;
providing a second data store associated with the second server;
providing means for synchronizing the first and second data stores;
creating a case workflow definition including a plurality of stage definitions, each stage definition specifying how data for an individual stage should be processed at that stage including specifying any permitted user interactions, and each stage definition including an indicator for indicating which of the first and second servers will carry out the processing according to the definition at that stage; and
loading the case workflow definition onto the first and second servers.

12. A method of deploying a case management system as claimed in claim 11, in which the computer program code when executed on a server causes the server to:
read the case workflow definition,
retrieve case data from the server's associated data store, the case data for each case including an indication of what stage that case is at,
for all cases which are at a stage which the stage definition indicates may be carried out on the current server, processing the case data according to the stage definition, including seeking user input where required and specified in the stage definition, and
returning processed case data to the server's associated data store.

13. A method of deploying a case management system as claimed in claim 11, the method further comprising the steps of applying a first security configuration to the first server and applying a second security configuration to the second server.

14. A method of deploying a case management system as claimed in claim 13, in which the first security configuration includes a data access configuration specifying how the first server stores and retrieves data in its associated data store, and in which the second security configuration includes a data access configuration specifying how the second server stores and retrieves data in its associated data store.

15. A method of deploying a case management system as claimed in claim 14, in which the first data access configuration causes the data in the data store associated with the first server to be encrypted.

16. A method of deploying a case management system as claimed in claim 14, in which the first data access configuration causes data relating to a particular case in the data store associated with the first server to be encrypted with a key unique to that particular case.

17. A method of deploying a case management system as claimed in claim 16, in which the second data access configuration causes data relating to a particular case in the data store associated with the second server not to be encrypted with a key unique to that particular case.

18. A method of deploying a case management system as claimed in claim 11, in which the first server has a user interface which is accessible from the Internet, and in which the second server has a user interface which is accessible only from hosts on a particular network.

19. A method of deploying a case management system as claimed in claim 12, the method further comprising the steps of applying a first security configuration to the first server and applying a second security configuration to the second server, the first security configuration including a data access configuration specifying how the first server stores and retrieves data in its associated data store, and the second security configuration including a data access configuration specifying how the second server stores and retrieves data in its associated data store, the first data access configuration causing the data in the data store associated with the first server to be encrypted, a different key being used to encrypt case data relating to each different case, and the second data access configuration causing the data in the data store associated with the second server not to be encrypted, or to be encrypted with a key which is not different for each case.

20. A method of deploying a case management system as claimed in claim 19, in which the first server has a user interface which is accessible from the Internet, and in which the second server has a user interface which is accessible only from hosts on a particular network.
